(19) United States
(12) Patent Application Publication
(10) Pub. No.: US 2026/0275120 A1
(43) Pub. Date: Sep. 17, 2026

(54) COMPOSITIONS CONTAINING CYCLIC AMINES AND INORGANIC METAL OXIDES

(71) Applicant: Dow Global Technologies LLC, Midland, MI (US)

(72) Inventors: Jing Ji, Shanghai (CN); Xue Chen, Pearland, TX (US)

(21) Appl. No.: 19/469,965

(22) PCT Filed: Jun. 5, 2023
(86) PCT No.: PCT/CN2023/098231

§ 371 Date: Sep. 26, 2025

(51) Int. Cl. C09D 5/02; C08K 3/22; C08K 5/3415; C08K 5/3432; C08K 5/3462

(52) U.S. Cl. CPC C09D 5/024; C08K 3/22; C08K 5/3415; C08K 5/3432; C08K 5/3462

(57) ABSTRACT

Compositions comprising at least the following components a and b): a) at least one structure selected from Structures 1), 2), 3), each as described herein, or any combination thereof; and b) at least one inorganic metal oxide. Also, processes to form such compositions and articles from such compositions.

### BACKGROUND OF THE INVENTION

To improve the protection of the environment, the demand for non-VOC and low odor raw materials for paint and other coatings has increased significantly in recent years. The main components in paint and coating formulations, such as emulsions and coalescing agents, have already met the requirements of non-VOC and low odor. The control of each VOC (Volatile Organic Compound) and the odor associated with each additive is important to further improve the quality of such products. Also, in addition to low VOC, it is important that the paint or coating have excellent viscosity stability and pH stability and good abrasion resistance.

The pH neutralizer is an important additive for paints and coatings. Although typically used only at 0.1 wt % to 0.5 wt % of the total formulation, it has a significant influence on the overall performance of the final product. A widely used neutralizer is 2-amino-2-methyl-1-propanol. It is accepted by the coatings industry for its multifunctional benefits beyond pH neutralization, such as, its ability to improve the dispersion of pigments, and its ability to improve the pH stability of the final composition. However, the boiling point of 2-amino-2-methyl-1-propanol is 165° C., and according to the VOC test method in GB/T 18582-2020, this propanol is considered a VOC. Thus, there is a need for paint and coating compositions that have reduced VOC content, while achieving excellent viscosity stability and pH stability, and good abrasion resistance.

CN108912281B (machine translation) discloses a water-based epoxy resin that contains the following: a) 45-80 parts methyl methacrylate, b) 20-50 parts of butyl acrylate, c) 8-15 parts of hydroxyethyl acrylate, d) 10-18 parts of acrylic acid, e) 1-5 parts of a silane coupling agent, f) 1-5 parts of an initiator, g) 4-15 parts of an epoxy resin, h) 10-20 parts of a neutralizer, and i) 130-300 parts of water. See its abstract. This references also discloses a water-based OP protective agent that consists of the following: a) 550-650 parts of a water-based epoxy resin, b) 65-90 parts of a curing agent, c) 1-10 parts of a catalyst, d) 0-3 parts of a flatting agent, e) 20-50 parts of a cosolvent, f) 0-3 parts of a neutralizer, g) 0-1 part of a defoaming agent, and h) 200-250 parts of water. See its abstract. The water-based OP protective agent is disclosed as safe and nontoxic, and as having a good coating effect, strong adhesive force and high heat resistance. See its abstract. The neutralizing agent is at least one of diethanolamine, ethanolamine, triethylamine, 2-amino-2-methyl-1-propanol, N-methyl-diethanolamine and N,N-dimethylethanolamine (see claim 1).

CN102675999B (machine translation) discloses a water-based fluorocarbon paint for silicate concrete curbs, which is prepared from the following components (by mass percentage): a) 48.0-78.1% of a water-based fluorocarbon emulsion, b) 13.5-30.1% of a pigment, c) 0.2-2.3% of a wetting dispersant, d) 0-0.52% of a neutralizer, e) 0.1-0.5% of an organosilicon defoaming agent, f) 0-0.5% of a preservative, g) 0.1-3.2% of a thickening agent, h) 1.0-5.1% of a film-forming assistant, i) 1.0-4.2% of an antifreezing agent, j) 1.1-5.7% of a water-based interfacial agent, and k) 0.5-10.2% of water. See its abstract. The pH value of the paint is 8.0-9.5. It is disclosed that the paint has the characteristics of weather resistance, temperature change resistance, no toxicity and no smell. See its abstract. The neutralizing agent can be selected from conventional neutralizing agents used in paint field. Such agent is preferably 2-amino-2-methyl-1-propanol. See Summary of the Invention. Pigments include carbon black, organic yellow and rutile titanium dioxide. See Summary of the Invention.

U.S. Pat. No. 5,626,915 discloses a water-based coating composition that contains the following: a) a halogenated resin, b) a polyol, c) a surfactant, and d) an amine. See its abstract. Preferred amines include primary, secondary and tertiary alkyl amines, alkyldiamines. alkanolamines. dialkanolamines, and poly(oxyalkylene)diamines. A highly preferred group of amines further contains amines having one or more hydroxy or alkoxy (ether) groups, and an average molecular weight in the range of about 50 to about 7,000. Preferred group of amines are primary, secondary and tertiary aliphatic amines having a functionality of 1 to 3, and can be represented by the formulas: R1-N(R2)(R3), R1(R2)-N—R3-N(R4)R5, R1(R2)N—R3-N(R4)-R5-N(R6)R7. In these formulas, R1-R7 are independently selected from H or a straight or branched chain alkyl. hydroxyalkyl or alkoxylalkyl groups of about 1 to about 20 carbon atoms; R1-R7 can additionally include a substituted alkyl group, i.e., where one or more of the carbons in the radical is replaced with, or has substituted thereon, another functionality; for example an amine, ether, hydroxy or mercapto moiety, e.g., tris-(3-aminopropyl) amine. See, for example, column 6, lines 11-42. The composition may contain additives, such as a pigment (such as carbon black), thickeners, a filler, a glycol, a surfactant and water. See column 10, lines 36-57.

U.S. Pat. No. 8,853,308 discloses a composition containing the following: a) at least one (poly)isocyanate, b) at least one surfactant comprising an acid or a mixture of acids, and an optionally heterocyclic amine or polyamine or a mixture of such amies. The amine, or polyamine or at least one amine of said mixture carrying at least one alkylene oxide, preferably ethylene oxide, functional group. See abstract. The amine constituting said surfactant can be a heterocyclic amine, also the for the heterocyclic amine, the alkylene oxide functional group is preferably carried by the nitrogen atom of the amine functional group. See, for example, column 1, lines 53-58. Coating compositions may contain additives, such as antifoams, pigments or coloring agents and additives that provide resistance to scratches or graffiti. See column 19, lines 31-38.

However, as discussed above, there remains a need for paint and coating compositions that have reduced VOC content, while achieving excellent viscosity stability and pH stability, and good abrasion resistance. This need has been met by the following invention.

### SUMMARY OF THE INVENTION

A composition comprising at least the following components a and b):
a) at least one structure selected from Structures 1), 2), 3) or any combination thereof:

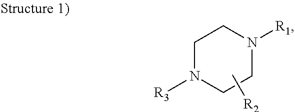

wherein R1 is a C1-C6 alkoxyl group; R2 is H or an alkyl group; R3 is H or a C1-C6 alkoxyl group;

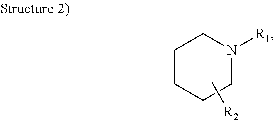

wherein R1 is a C1-C6 alkoxyl group; R2 is H or an alkyl group;

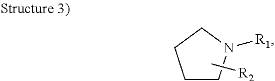

wherein R1 is a C1-C6 alkoxyl group; R2 is H or an alkyl group; and
b) at least one inorganic metal oxide.

### BRIEF DESCRIPTION OF THE DRAWINGS

FIG. 1 is a plot of the boiling point of 1,4-bis(2-hydroxyethyl)piperazine as a function of “mm Hg.” The equation of the profile is y=26.385 ln(x)+118.53 (R²=0.9616).

### DETAILED DESCRIPTION OF THE INVENTION

New compositions have been developed, which have no or very low VOC content, excellent viscosity stability and pH stability, and good abrasion resistance. As discussed above, a composition is provided, which comprises at least the following components a and b): a) at least one structure selected from Structures 1), 2), 3), each as described herein, or any combination of these structures; and b) at least one inorganic metal oxide.

The above composition may comprise a combination of two or more embodiments, as described herein. Component a may comprise a combination of two or more embodiments, as described herein. Component b may comprise a combination of two or more embodiments, as described herein. Each structure (Structure 1), Structure 2) and Structure 3)) may, independently, comprise a combination of two or more embodiments, as described herein. As used herein, in regard to Structure 1), Structure 2) or Structure 3) of component a, R1=R₁, R2=R₂, and so on.

In one embodiment, or a combination of two or more embodiments, each described herein, the weight ratio of component b to component a is ≥40, or ≥50, or ≥60, or ≥70, or ≥80, or ≥90, or ≥100, or ≥120, or ≥140, or ≥160, or ≥170, or ≥180, or ≥190, or ≥200. In one embodiment, or a combination of two or more embodiments, each described herein, the weight ratio of component b to component a is ≤500, or ≤450, or ≤400, or ≤350, or ≤300, or ≤280, or ≤260, or ≤240, or ≤220, or ≤210.

In one embodiment, or a combination of two or more embodiments, each described herein, for component a, Structure 1, R1=R3.

In one embodiment, or a combination of two or more embodiments, each described herein, component a is selected from at least one structure selected from the group consisting of the following structures 1a) through 4g) as shown below:

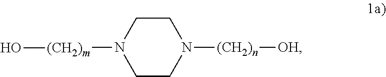

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and further n=m;

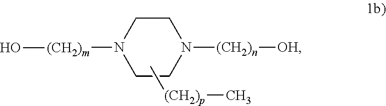

where n is an integer from 1 to 6, further from 1 to 5, further from 1 to 4, further from 2 to 4, further from 2 to 3, further 2; m is an integer from 1 to 6, further from 1 to 5, further from 1 to 4, further from 2 to 4, further from 2 to 3, further 2; further n=m; and p is an integer from 0 to 5, further from 0 to 4, further from 0 to 3, further from 0 to 2, further from 0 to 1, further 0;

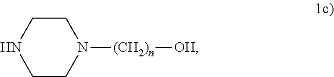

where n is an integer from 1 to 6; further from 1 to 5, further from 1 to 4, further from 2 to 4, further from 2 to 3, further 2;

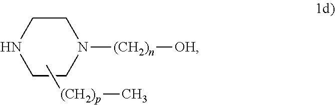

where n is an integer from 1 to 6; further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0;

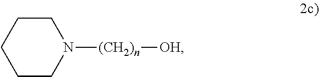

where n is an integer from 1 to 6, further from 1 to 5, further from 1 to 4, further from 2 to 4, further from 2 to 3, further 2;

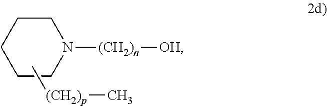

where n is an integer from 1 to 6, further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0;

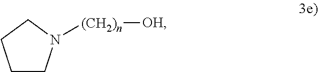

where n is an integer from 1 to 6, further from 1 to 5, further from 1 to 4, further from 2 to 4, further from 2 to 3, further 2;

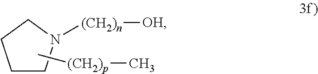

where n is an integer from 1 to 6, further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0; and 4g) any combination thereof.

In one embodiment, or a combination of two or more embodiments, each described herein, for component a, Structures 1), 2), and 3) each, independently, has a boiling point (at 760 mm Hg) ≥250° C., or ≥251° C., or ≥252° C., or ≥255° C., or ≥260° C., or ≥270° C., or ≥280° C., or ≥290° C., or ≥300° C. In one embodiment, or a combination of two or mor e embodiments, each described herein, for component a, Structures 1), 2), and 3) each, independently, has a boiling point (at 760 mm Hg)≤400° C., or ≤380° C., or ≤360° C., or ≤340° C., or ≤330° C., or ≤320° C., or ≤310° C.

In one embodiment, or a combination of two or more embodiments, each described herein, component a is selected from Structure 1). In one embodiment, or a combination of two or more embodiments, each described herein, component a is at least one structure selected from the group consisting of the following structures 1a), 1b) and 4g), each as shown herein. In one embodiment, or a combination of two or more embodiments, each described herein, component a is at least one structure selected Structure 1a), and further n=m, further n=m=2 or 3, further n=m=2.

In one embodiment, or a combination of two or more embodiments, each described herein, component b is a metal dioxide, and further titanium dioxide.

In one embodiment, or a combination of two or more embodiments, each described herein, the composition further comprises at least one filler as component c. In one embodiment, or a combination of two or more embodiments, each described herein, the composition comprises, as component c, at least three fillers (F1, F2 and F3), and further three fillers (F1, F2 and F3).

In one embodiment, or a combination of two or more embodiments, each described herein, the composition further comprises water as component d. In one embodiment, or a combination of two or more embodiments, each described herein, the composition further comprises a polymer emulsion as component e. In one embodiment, or a combination of two or more embodiments, each described herein, component e is selected from a acrylic polymer emulsion, and further an acrylic styrene copolymer emulsion.

In one embodiment, or a combination of two or more embodiments, each described herein, component a is present in an amount ≥0.005 wt %, or ≥0.01 wt %, or ≥0.02 wt %, or ≥0.03 wt %, or ≥0.04 wt %, or ≥0.05 wt %, based on the weight of the composition. In one embodiment, or a combination of two or more embodiments, each described herein, component a is present in an amount ≤3.0 wt %, or ≤2.0 wt %, or ≤1.0 wt %, or ≤0.50 wt %, or ≤0.20 wt %, or ≤0.10 wt %, or ≤0.08 wt %, based on the weight of the composition.

In one embodiment, or a combination of two or more embodiments, each described herein, component b is present in an amount ≥2.0 wt %, or 3.0 wt %, or ≥4.0 wt %, or ≥5.0 wt %, or ≥6.0 wt %, or 7.0 wt %, or ≥8.0 wt %, or ≥9.0 wt %, based on the weight of the composition. In one embodiment, or a combination of two or more embodiments, each described herein, component b is present in an amount ≤50 wt %, or ≤45 wt %, or ≤40 wt %, or ≤35 wt %, or ≤30 wt %, or ≤25 wt %, or ≤20 wt %, or ≤15 wt %, or ≤12 wt %, or ≤11 wt %, or ≤10 wt %, based on the weight of the composition.

In one embodiment, or a combination of two or more embodiments, each described herein, the sum of components a, b, c and d is present in an amount ≥70 wt %, or 72 wt %, or ≥74 wt %, or ≥76 wt %, or ≥78 wt %, or ≥80 wt %, or ≥82 wt %, based on the weight of the composition. In one embodiment, or a combination of two or more embodiments, each described herein, the sum of components a, b, c and d is present in an amount ≤95 wt %, or ≤90 wt %, or ≤88 wt %, or ≤86 wt %, or ≤84 wt %, or ≤83 wt %, based on the weight of the composition.

In one embodiment, or a combination of two or more embodiments, each described herein, the composition has a scrub resistance, as indicated by the number of scrub strokes to create a crack in a coating formed from the composition, ≥1800, or ≥1850, or ≥1900, or ≥1920, or ≥1950, or ≥1980, or ≥2000. See Experimental section.

In one embodiment, or a combination of two or more embodiments, each described herein, the composition has a thermal storage stability as indicated by a pH rate (%) increase ≤1.0, or ≤0.80, or ≤0.60, or ≤0.40, or ≤0.20, or ≤0.10. See Experimental section: 50° C. for 10 days, circulating air. In one embodiment, or a combination of two or more embodiments, each described herein, the composition has a freeze-thaw stability as indicated by a pH rate (%) increase ≤3.0, or ≤2.8, or ≤2.6, or ≤2.4, or ≤2.3, or ≤2.2. See Experimental section: −6° C. for 16 hours, air, then at a temperature from 22° C. to 23° C. for 8 hours, air.

In one embodiment, or a combination of two or more embodiments, each described herein, the composition has a thermal storage stability as indicated by a KU viscosity rate (%) increase ≤9.0, or ≤8.5, or ≤8.0, or ≤7.5, or ≤7.0, or ≤6.5. See Experimental section: 50° C. for 10 days, circulating air. In one embodiment, or a combination of two or more embodiments, each described herein, the composition has a freeze-thaw stability as indicated by KU viscosity rate (%) increase ≤15, or ≤10, or ≤8.0, or ≤6.0, or ≤5.0, or ≤4.5, or ≤4.3, or ≤4.2, and/or ≥0.5. See Experimental section: −6° C. for 16 hours, air, then at a temperature from 22° C. to 23° C. for 8 hours, air.

In one embodiment, or a combination of two or more embodiments, each described herein, the composition has a KU viscosity after 24 hours at a temperature from 22° C. to 23° C., ambient atm., ≤500, or ≤400, or ≤300, or ≤250, or ≤200, or ≤150, or ≤140, or ≤130, or ≤125, and/or ≥80, or ≥90, or ≥95, or ≥100, or ≥105, or ≥110, or ≥115 Krebs units. In one embodiment, or a combination of two or more embodiments, each described herein, the composition has a pH value after 24 hours at a temperature from 22° C. to 23° C., ambient atm., ≤7.88, or ≤7.89, or ≤7.90, or ≤7.91, and/or ≥10.0, or ≥9.50, or ≥9.00, or ≥8.50, or ≥8.20, or ≥8.10, or ≥8.08, or ≥8.06, or ≥8.04, or ≥8.02, or ≥8.00.

In one embodiment, or a combination of two or more embodiments, each described herein, the composition is a paint or a coating.

Also provided is a process to form the composition of any one embodiment, or a combination of two or more embodiments described herein, said process comprising mixing at least components a and b. In one embodiment, or a combination of two or more embodiments, each described herein, the process comprises mixing at least components a, b in the presence of at least a portion of component d (water).

Also provided is a process of coating a surface, the process comprising applying to the surface the composition of any one embodiment, or a combination of two or more embodiments described herein. In one embodiment, or a combination of two or more embodiments, each described herein, the surface is a cement surface, a wood surface, a plastic surface, a metal surface, a ceramic surface or a fabric surface, and further a cement surface, a wood surface, a plastic surface, or a metal surface.

Also provided is an article formed from the composition of any one embodiment, or a combination of two or more embodiments described herein. In one embodiment, or a combination of two or more embodiments, each described herein, the article is a coated surface. In one embodiment, or a combination of two or more embodiments, each described herein, the surface is a cement surface, a wood surface, a plastic surface, a metal surface, a ceramic surface or a fabric surface, and further a cement surface, a wood surface, a plastic surface, or a metal surface.

Component a—Cyclic Amine

Component a is described herein. Syntheses of the cyclic amines are known in the art, and various ether amines are also commercially available. For example, the cyclic amines can be generated by reacting the oxides with the related amines (pyrrolidine, piperidine, piperazine). Further as an example, 1,4-bis(2-hydroxyethyl)piperazine can be synthesized by reacting the EO (ethylene oxide) and the piperazine at the targeted ratio of 2:1. This cyclic amine can be recovered using conventional technologies.

Component a can be in the form of a liquid composition that is added to an aqueous composition. The cyclic amine per se can be in the form of a liquid at room temperature (22° C.), and therefore a “stock” composition can be one where the cyclic amine is in neat form (100% wt). A stock composition can also be prepared with the cyclic amine in one or more compatible solvents, such as, for example, where the cyclic amine is present in an amount in the range of about 30% (wt) to about 99% (wt). The solvent may be water. The cyclic amine may be in the form of a solid composition, such as in powder or granule form that can be added to an aqueous composition.

Component b—Inorganic Metal Oxides

Inorganic metal oxides are described herein. Such oxides include, but are not limited to, the following: Titanium(IV) oxide (TiO₂), Titanium(II) oxide (TiO), Titanium(III) oxide (Ti₂O₃), Iron(II) oxide (FeO), Iron(III) oxide (Fe₂O₃), and Fe₃O₄.

### Other Polymers

A composition may optionally include one or more additional polymer(s). Examples include, but are not limited to, block or random copolymers of ethylene oxide/propylene oxide, butylene oxide/propylene oxide, ethylene oxide/butylene oxide; waxes; and silicone-based polymers.

### Definitions

Unless stated to the contrary, implicit from the context, or customary in the art, parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The phrase “at least a portion of,” as used herein, in reference to the amount of a component in a mixing process, refers to at least 20 wt %, and typically at least 50 wt %, of the total weight of the component added to the mixing process.

The term “inorganic metal oxide,” as used herein, refers to a molecular compound containing one or more oxygen (O) atoms and at least one metal (M) atom with an atomic mass ≥42 g/mol; and not containing carbon (C) atoms and not containing hydrogen (H) atoms. Examples of metal (M) atoms include, but are not limited to, Ti, Zr, La, Fe, Cr, Zn, Ba, Co, Cu and Ni. Examples of inorganic metal oxides include, but are not limited to, TiO₂, Fe₂O₃, ZrO₂, ZnO, and NiO.

The term “water,” as used herein, refers to H₂O or an H₂O sample. Such a water (H₂O) sample is virtually pure water, and as such, may or may not contain one or more impurities, such as, for example, dissolved inorganic ions. Typically, the impurities are present in an amount ≤5000 ppm, preferable ≤2000 ppm, preferably, ≤1000 ppm, preferably ≤100 ppm, more preferably ≤10 ppm, more preferably ≤1 ppm, based on the weight of the water sample.

The term “polymer emulsion,” as used herein, refers to the product of an emulsion polymerization of a composition comprising a solvent (typically water), one or more monomer types and a surfactant.

The term “acrylic polymer emulsion,” as used herein, refers to the product of an emulsion polymerization of a composition comprising a solvent (typically water), an acrylate and/or an acrylic acid, and optionally one or more other monomer types, and a surfactant. Acrylic polymer emulsions are typically water-based, and they can be produced from methyl methacrylate, butyl acrylate, 2-ethylhexyl acrylate, acrylic acid, methyl acrylate and/or similar monomers.

The terms “paint” and “coating” as used herein, each refer to a composition which is spread (for example, via a brush, a roller or a spraying device) over a surface and then dried, to leave a layer for decoration and/or protection of the surface.

The term “freeze-thaw” stabilizer, as used herein, refers to a substance that shows a resistance to deterioration after repeated temperature cycling. For example, repeated (2) temperature cycles, in air, from −6° C. to a temperature from “22° C. to 23° C.” Examples of such substances, include, but are not limited to, alkylene glycols, such as ethylene glycol and propylene glycol. See Experimental section.

The term “dispersing agent,” as used herein, refers to a substance, typically a surfactant, that is added to a suspension of solid particles and/or liquid particles in a liquid (such as an emulsion or a colloid) to improve the separation of the particles and prevent settling and/or clumping of the particles. Examples of dispersing agent include, but are not limited to, surfactants, copolycarboxylates and acrylic polymers.

The term “wetting agent,” as used herein, refers to substance that is added to a liquid to reduce the surface tension of the liquid and to make the liquid more effective in spreading over and penetrating surfaces. Examples of wetting agents include, but are not limited to, surfactants, alcohols and fatty acids.

The term “anti-foaming agent,” as used herein, refers to substance that reduces the formation of foam in a liquid composition. Examples of anti-foaming agents include, but are not limited to, polydimethylsiloxanes and other silicone derivatives, oils and stearates.

The term “rheology modifier,” as used herein, refers to substance that alters the rheological properties of a material (for example a liquid composition). Examples of rheology modifiers include, but are not limited to, cellulose derivatives, nonionic urethane resins, and hydrophobically modified polymers.

The term “coalescing agent,” as used herein, refers to substance that reduces the minimum film forming temperature of a polymer in a composition. Examples of coalescing agents include, but are not limited to, alcohol esters and glycol ethers.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition and Process Features

A] A composition comprising at least the following components a and b):
a) at least one structure selected from Structures 1), 2), 3) or any combination thereof:

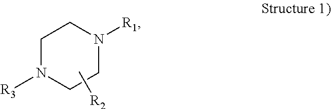

wherein R1 is a CL-C6 alkoxyl group; R2 is H or an alkyl group; R3 is H or a C1-C6 alkoxyl group;

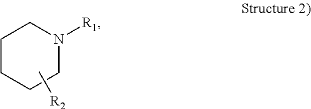

wherein R1 is a C1-C6 alkoxyl group; R2 is H or an alkyl group;

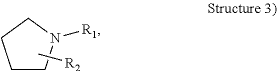

wherein R1 is a C1-C6 alkoxyl group; R2 is H or an alkyl group; and
b) at least one inorganic metal oxide.

B] The composition of A] above, where the weight ratio of component b to component a is ≥40, or ≥50, or ≥60, or ≥70, or ≥80, or ≥90, or ≥100, or ≥120, or ≥140, or ≥160, or ≥170, or ≥180, or ≥190, or ≥200.

C] The composition of A] or B] above, where the weight ratio of component b to component a is ≤500, or ≤450, or ≤400, or ≤350, or ≤300, or ≤280, or ≤260, or ≤240, or ≤220, or ≤210.

D] The composition of any one of A]-C] (A] through C]) above, where, for component a, Structure 1, R1=R3.

E] The composition of any one of A]-D] above, where, for component a, Structure 1, R2=H.

F] The composition of any one of A]-E] above, where, for component a, Structure 2, R2=H.

G] The composition of any one of A]-F] above, where, for component a, Structure 3, R2=H.

H] The composition of any one of A]-D] above, where, for component a, Structure 1, R2 is a C1-C6 alkyl, further a C1-C5 alkyl, further a C1-C4 alkyl, further a C1-C3 alkyl, further a C1-C2 alkyl, further a C1 alkyl.

I] The composition of any one of A]-D] above, where, for component a, Structure 2, R2 is a C1-C6 alkyl, further a C1-C5 alkyl, further a C1-C4 alkyl, further a C1-C3 alkyl, further a C1-C2 alkyl, further a C1 alkyl.

J] The composition of any one of A]-D] above, where, for component a, Structure 3, R2 is a C1-C6 alkyl, further a C1-C5 alkyl, further a C1-C4 alkyl, further a C1-C3 alkyl, further a C1-C2 alkyl, further a C1 alkyl.

K] The composition of any one of A]-J] above, where, for component a, Structure 1, R1 is a C1-C5 alkoxyl, further a C1-C4 alkoxyl, further a C1-C3 alkoxyl, further a C1-C2 alkoxyl, further a C2 alkoxyl.

L] The composition of any one of A]-K] above, where, for component a, Structure 1, R1 is a C2-C6 alkoxyl, further a C2-C5 alkoxyl, further a C2-C4 alkoxyl, further a C2-C3 alkoxyl, further a C2 alkoxyl.

M] The composition of any one of A]-L] above, where, for component a, Structure 1, R3 is a C1-C5 alkoxyl, further a C1-C4 alkoxyl, further a C1-C3 alkoxyl, further a C1-C2 alkoxyl, further a C2 alkoxyl.

N] The composition of any one of A]-M] above, where, for component a, Structure 1, R3 is a C2-C6 alkoxyl, further a C2-C5 alkoxyl, further a C2-C4 alkoxyl, further a C2-C3 alkoxyl, further a C2 alkoxyl.

O] The composition of any one of A]-N] above, where, for component a, Structure 2, R1 is a C1-C5 alkoxyl, further a C1-C4 alkoxyl, further a C1-C3 alkoxyl, further a C1-C2 alkoxyl, further a C2 alkoxyl.

P] The composition of any one of A]-O] above, where, for component a, Structure 2, R1 is a C2-C6 alkoxyl, further a C2-C5 alkoxyl, further a C2-C4 alkoxyl, further a C2-C3 alkoxyl, further a C2 alkoxyl.

Q] The composition of any one of A]-P] above, where, for component a, Structure 3, R1 is a C1-C5 alkoxyl, further a C1-C4 alkoxyl, further a C1-C3 alkoxyl, further a C1-C2 alkoxyl, further a C2 alkoxyl.

R] The composition of any one of A]-Q] above, where, for component a, Structure 3, R1 is a C2-C6 alkoxyl, further a C2-C5 alkoxyl, further a C2-C4 alkoxyl, further a C2-C3 alkoxyl, further a C2 alkoxyl.

S] The composition of any one of A]-L] above, where, for component a, Structure 1, R3 is H.

T] The composition of any one of A]-S] above, where component a is selected from at least one structure selected from the group consisting of the following structures 1a) through 4g) as shown below:

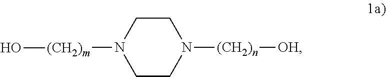

where n is an integer from 1 to 6, further from 1 to 5, further from 1 to 4, further from 2 to 4, further from 2 to 3, further 2; and m is an integer from 1 to 6, further from 1 to 5, further from 1 to 4, further from 2 to 4, further from 2 to 3, further 2; and further n=m;

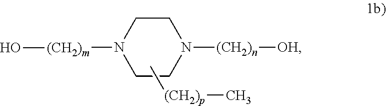

where n is an integer from 1 to 6, further from 1 to 5, further from 1 to 4, further from 2 to 4, further from 2 to 3, further 2; m is an integer from 1 to 6, further from 1 to 5, further from 1 to 4, further from 2 to 4, further from 2 to 3, further 2; further n=m; and p is an integer from 0 to 5, further from 0 to 4, further from 0 to 3, further from 0 to 2, further from 0 to 1, further 0;

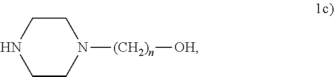

where n is an integer from 1 to 6; further from 1 to 5, further from 1 to 4, further from 2 to 4, further from 2 to 3, further 2;

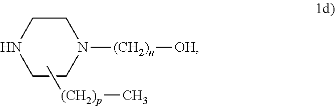

where n is an integer from 1 to 6; further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0;

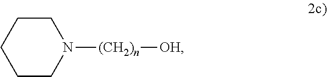

where n is an integer from 1 to 6, further from 1 to 5, further from 1 to 4, further from 2 to 4, further from 2 to 3, further 2;

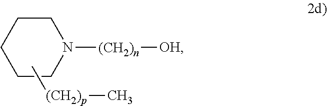

where n is an integer from 1 to 6, further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0;

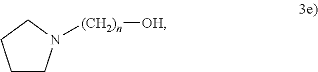

where n is an integer from 1 to 6, further from 1 to 5, further from 1 to 4, further from 2 to 4, further from 2 to 3, further 2;

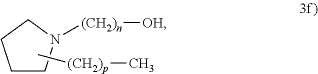

where n is an integer from 1 to 6, further from 1 to 5, further from 1 to 4, further from 2 to 4, further from 2 to 3, further 2; and p is an integer from 0 to 5, further from 0 to 4, further from 0 to 3, further from 0 to 2, further from 0 to 1, further 0; and 4g) any combination thereof.

U] The composition of any one of A]-T] above, where component a is at least one structure selected from the group consisting of the following structures 1a), 2c), 3e) and 4g), each as shown above.

V] The composition of any one of A]-T] above, where component a is at least one structure selected from the group consisting of the following structures 1b), 2d), 3f) and 4g), each as shown above.

W] The composition of any one of A]-T] above, where component a is at least one structure selected from the group consisting of the following structures 1a), 1b), 1c), 1d) and 4g), each as shown above.

X] The composition of any one of A]-T] above, where component a is at least one structure selected from the group consisting of the following structures 1a), 1b) and 4g), each as shown above.

Y] The composition of any one of A]-T] above, where component a is at least one structure selected Structure 1a), and further n=m, further n=m=2 or 3, further n=m=2.

Z] The composition of any one of A]-T] above, where for component a, Structures 1), 2), and 3) each, independently, has a molecular weight ≥80, or ≥85, or ≥90, or ≥95, or ≥100, or ≥105, or ≥110 g/mol

A2] The composition of any one of A]-Z] above, where for component a, Structures 1), 2), and 3) each, independently, has a molecular weight ≤500, or ≤450, or ≤400, or ≤350, or ≤300, or ≤250, or ≤200, or ≤180 g/mol.

B2] The composition of any one of A]-Z] above, where for component a, Structures 1), 2), and 3) each, independently, has a molecular weight ≤200, or ≤195, or ≤190, or ≤185, or ≤180 g/mol.

C2] The composition of any one of A]-B2] above, where for component a, Structures 1), 2), and 3) each, independently, has a boiling point (at 760 mm Hg) ≥250° C., or ≥251° C., or ≥252° C., or ≥255° C., or ≥260° C., or ≥270° C., or ≥280° C., or ≥290° C., or ≥300° C.

D2] The composition of any one of A]-C2] above, where for component a, Structures 1), 2), and 3) each, independently, has a boiling point (at 760 mm Hg)≤400° C., or ≤380° C., or ≤360° C., or ≤340° C., or ≤330° C., or ≤320° C., or ≤310° C.

E2] The composition of any one of A]-D2] above, where component a is selected from Structure 1).

F2] The composition of E2] above, where component a is at least one structure selected from the group consisting of the following structures 1a), 1b) and 4g), each as shown above.

G2] The composition of E2] or F2] above, where component a is at least one structure selected Structure 1a), and further n=m, further n=m=2 or 3, further n=m=2.

H2] The composition of any one of A]-D2] above, where component a is selected from Structure 2).

I2] The composition of any one of A]-D2] above, where component a is selected from Structure 3).

J2] The composition of any one of A]-I2] above, where component b is a metal dioxide, and further titanium dioxide.

K2] The composition of any one of A]-J2] above, where the metal of the inorganic metal oxide of component b has an atomic mass ≥43, or ≥44, or ≥45, or ≥46 g/mol.

L2] The composition of any one of A]-K2] above, where the metal of the inorganic metal oxide of component b has an atomic mass ≤100, or ≤90, or ≤80, or ≤70, or ≤65, or ≤60, or ≤58, or ≤56, or ≤54, or ≤52, or ≤50 g/mol.

M2] The composition of any one of A]-L2] above, where the inorganic metal oxide has an molecular weight ≥60, or ≥65, or ≥70, or ≥72, or ≥74, or ≥76, or ≥78, or ≥80 g/mol.

N2] The composition of any one of A]-M2] above, where the inorganic metal oxide has an molecular weight ≤250, or ≤200, or ≤150, or ≤120, or ≤110, or ≤100, or ≤95, or ≤90 g/mol.

O2] The composition of any one of A]-N2] above, where the composition further comprises at least one filler as component c.

P2] The composition of O2] above, where component c is present in an amount ≥10 wt %, or ≥15 wt %, or ≥20 wt %, or ≥25 wt %, or ≥30 wt %, or ≥32 wt %, or ≥34 wt %, or ≥36 wt %, or ≥38 wt %, based on the weight of the composition.

Q2] The composition of O2] or P2] above, where the component c is present in an amount ≤65 wt %, or ≤60 wt %, or ≤55 wt %, or ≤50 wt %, or ≤48 wt %, or ≤46 wt %, or ≤44 wt %, or ≤42 wt %, or ≤40 wt %, based on the weight of the composition.

R2] The composition of any one of O2]-Q2] above, where the composition comprises, as component c, at least two fillers (F1 and F2).

S2] The composition of any one of O2]-R2] above, where the composition comprises, as component c, at least three fillers (F1, F2 and F3), and further three fillers (F1, F2 and F3).

T2] The composition of R2] or S2] above, where, for component c, filler F1 is present in an amount ≥40 wt %, or ≥42 wt %, or ≥44 wt %, or ≥46 wt %, or ≥48 wt %, or ≥50 wt %, based on the weight of component c.

U2] The composition of any one of R2]-T2] above, where, for component c, filler F1 is present in an amount ≤60 wt %, or ≤58 wt %, or ≤56 wt %, or ≤54 wt %, or ≤52 wt %, based on the weight of the composition.

V2] The composition of any one of R2]-U2] above, where, for component c, filler F1 is selected from a metal carbonate, a metal bicarbonate, or a mixture thereof, and further F1 is selected from a metal carbonate, or a mixture of a metal carbonate and a metal bicarbonate, and further F1 is a metal carbonate, and further CaCO₃.

W2] The composition of any one of R2]-V2] above, where, for component c, filler F2 is selected from a Al₂O₃, SiO₂ or a mixture thereof, and further F2 is selected from a mixture of Al₂O₃ and SiO₂.

X2] The composition of any one of R2]-W2] above, where, for component c, the weight ratio of F1 to F2 is ≥0.8, or ≥0.9, or ≥1.0, or ≥1.1, or ≥1.2, or ≥1.3, or ≥1.4, or ≥1.5.

Y2] The composition of any one of R2]-X2] above, where, for component c, the weight ratio of F1 to F2 is ≤2.4, or ≤2.2, or ≤2.0, or ≤1.9, or ≤1.8, or ≤1.7.

Z2] The composition of any one of S2]-Y2] above, where, for component c, the weight ratio of F1 to F3 is ≥2.0, or ≥2.2, or ≥2.4, or ≥2.6, or ≥2.8.

A3] The composition of any one of S2]-Z2] above, where, for component c, the weight ratio of F1 to F3 is ≤4.0, or ≤3.8, or ≤3.6, or ≤3.4, or ≥3.2, or ≥3.0.

B3] The composition of any one of O2]-A3] above, where the weight ratio of component c to component b is ≥2.0, or ≥2.5, or ≥2.8, or ≥3.0, or ≥3.2, or ≥3.4, or ≥3.6, or ≥3.8.

C3] The composition of any one of O2]-B3] above, where the weight ratio of component c to component b is ≤6.0, or ≤5.5, or ≤5.0, or ≤4.8, or ≥4.6, or ≥4.4, or ≥4.2, or ≥4.0.

D3] The composition of any one of A]-C3] above, where the composition further comprises water as component d.

E3] The composition of D3] above, where the component d is present in an amount ≥15 wt %, or ≥18 wt %, or ≥20 wt %, or ≥22 wt %, or ≥24 wt %, or ≥26 wt %, or ≥28 wt %, or ≥30 wt %, or ≥32 wt %, based on the weight of the composition.

F3] The composition of D3] or E3] above, where the component d is present in an amount ≤50 wt %, or ≤48 wt %, or ≤46 wt %, or ≤44 wt %, or ≤42 wt %, or ≤40 wt %, or ≤38 wt %, or ≤36 wt %, or ≤34 wt %, based on the weight of the composition.

G3] The composition of any one of E3]-F3] above, where the weight ratio of component d to component a is ≥400, or ≥450, or ≥500, or ≥550, or ≥600, or ≥650.

H3] The composition of any one of D3]-G3] above, where the weight ratio of component d to component a is ≤1000, or ≤900, or ≤850, or ≤800, or ≤750, or ≤700.

I3] The composition of any one of D3]-H3] above, where the weight ratio of component d to component b is ≥2.0, or ≥2.2, or ≥2.5, or ≥2.8, or ≥3.0, or ≥3.1, or ≥3.2, or ≥3.3.

J3] The composition of any one of D3]-I3] above, where the weight ratio of component d to component b is ≤5.0, or ≤4.5, or ≤4.2, or ≤4.0, or ≥3.8, or ≤3.6, or ≤3.4.

K3] The composition of any one of D3]-J3] above, where the weight ratio of component d to component c is ≥0.70, or ≥0.75, or ≥0.80, or ≥0.82, or ≥0.84, or ≥0.85, or ≥0.86.

L3] The composition of any one of D3]-K3] above, where the weight ratio of component d to component c is ≤1.0, or ≤0.98, or ≤0.96, or ≤0.94, or ≤0.92, or ≤0.90, or ≤0.88.

M3] The composition of any one of A]-L3] above, where the composition further comprises a polymer emulsion as component e.

N3] The composition of M3] above, where the component e is present in an amount ≥5.0 wt %, or ≥6.0 wt %, or ≥7.0 wt %, or ≥8.0 wt %, or ≥9.0 wt %, or ≥10 wt %, or ≥11 wt %, or ≥12 wt, based on the weight of the composition.

O3] The composition of M3] or N3] above, where the component e is present in an amount ≤35 wt %, or ≤30 wt %, or ≤25 wt %, or ≤20 wt %, or ≤19 wt %, or ≤18 wt %, or ≤17 wt %, or ≤16 wt %, or ≤14 wt %, or ≤13 wt %, based on the weight of the composition.

P3] The composition of any one of M3]-03] above, where the weight ratio of component e to component b is ≥0.80, or ≥0.85, or ≥0.90, or ≥0.95, or ≥1.0, or ≥1.1, or ≥1.2.

Q3] The composition of any one of M3]-P3] above, where the weight ratio of component e to component b is ≤3.0, or ≤2.8, or ≤2.5, or ≤2.2, or ≤2.0, or ≤1.8, or ≤1.6, or ≤1.4, or ≤1.3.

R3] The composition of any one of M3]-Q3] above, where component e is selected from an acrylic polymer emulsion, and further an acrylic styrene copolymer emulsion.

S3] The composition of any one of A]-R3] above, where the composition further comprises, as component f, at least one additive, further at least two additives, further at least three additives.

T3] The composition of S3] above, where the at least one additive of component f is selected from the following a freeze-thaw stabilizer, a dispersing agent, a wetting agent, an anti-foaming agent, a rheology modifier, a coalescing agent or a combination thereof.

U3] The composition of S3] or T3] above, where component f comprises three rheology modifiers.

V3] The composition of any one of S3]-U3] above, where the component f comprises a freeze-thaw stabilizer, a dispersing agent, a wetting agent, an anti-foaming agent, three rheology modifiers, and a coalescing agent.

W3] The composition of any one of S3]-V3] above, where the component f is present in an amount 3.0 wt %, or 3.5 wt %, or ≥4.0 wt %, or ≥4.2 wt %, or ≥4.4 wt %, or ≥4.6 wt, or ≥4.8 wt %, or ≥5.0 wt %, based on the weight of the composition, and/or ≤10 wt %, or ≤9.0 wt %, or ≤8.0 wt %, or ≤7.0 wt %, or ≤6.0 wt %, or ≤5.5 wt %, based on the weight of the composition.

X3] The composition of any one of A]-W3] above, where the component a is present in an amount ≥0.005 wt %, or ≥0.01 wt %, or ≥0.02 wt %, or ≥0.03 wt %, or ≥0.04 wt %, or ≥0.05 wt %, based on the weight of the composition.

Y3] The composition of any one of A]-X3] above, where the component a is present in an amount ≤3.0 wt %, or ≤2.0 wt %, or ≤1.0 wt %, or ≤0.50 wt %, or ≤0.20 wt %, or ≤0.10 wt %, or ≤0.08 wt %, based on the weight of the composition.

Z3] The composition of any one of A]-Y3] above, where the component b is present in an amount ≥2.0 wt %, or 3.0 wt %, or ≥4.0 wt %, or ≥5.0 wt %, or ≥6.0 wt %, or ≥7.0 wt %, or ≥8.0 wt %, or ≥9.0 wt %, based on the weight of the composition.

A4] The composition of any one of A]-Z3] above, where the component b is present in an amount ≤50 wt %, or ≤45 wt %, or ≤40 wt %, or ≤35 wt %, or ≤30 wt %, or ≤25 wt %, or ≤20 wt %, or ≤15 wt %, or ≤12 wt %, or ≤11 wt %, or ≤10 wt %, based on the weight of the composition.

B4] The composition of any one of A]-A4] above, where the sum of component a and component b is present in an amount ≥5.0 wt %, or 6.0 wt %, or ≥7.0 wt %, or 8.0 wt %, or ≥9.0 wt %, or ≥9.2 wt %, or ≥9.5 wt %, or ≥9.7 wt %, or ≥10 wt %, based on the weight of the composition.

C4] The composition of any one of A]-B4] above, where the sum of component a and component b is present in an amount ≤25 wt %, or ≤22 wt %, or ≤20 wt %, or ≤18 wt %, or ≤16 wt %, or ≤14 wt %, or ≤12 wt %, based on the weight of the composition.

D4] The composition of any one of O2]-C4] above, where the sum of components a, b and c is present in an amount ≥30 wt %, or 32 wt %, or ≥35 wt %, or ≥38 wt %, or ≥40 wt %, or 42 wt %, or ≥44 wt %, or ≥46 wt %, or ≥48 wt %, based on the weight of the composition.

E4] The composition of any one of O2]-D4] above, where the sum of components a, b and c is present in an amount ≤60 wt %, or ≤58 wt %, or ≤56 wt %, or ≤54 wt %, or ≤52 wt %, or ≤50 wt %, based on the weight of the composition.

F4] The composition of any one of D3]-E4] above, where the sum of components a, b and d is present in an amount ≥20 wt %, or 25 wt %, or ≥30 wt %, or ≥32 wt %, or ≥35 wt %, or ≥38 wt %, or ≥39 wt %, or 40 wt %, based on the weight of the composition.

G4] The composition of any one of D3]-F4] above, where the sum of components a, b and d is present in an amount ≤60 wt %, or ≤55 wt %, or ≤52 wt %, or ≤50 wt %, or ≤48 wt %, or ≤46 wt %, or ≤45 wt %, or ≤44 wt %, based on the weight of the composition.

H4] The composition of any one of D3]-G4] above, where the sum of components a, b, c and d is present in an amount ≥70 wt %, or 72 wt %, or ≥74 wt %, or ≥76 wt %, or ≥78 wt %, or ≥80 wt %, or ≥82 wt %, based on the weight of the composition.

I4] The composition of any one of D3]-H4] above, where the sum of components a, b, c and d is present in an amount ≤95 wt %, or ≤90 wt %, or ≤88 wt %, or ≤86 wt %, or ≤84 wt %, or ≤83 wt %, based on the weight of the composition.

J4] The composition of any one of M3]-I4] above, where the sum of components a, b, c, d and e is present in an amount ≥80 wt %, or 85 wt %, or ≥90 wt %, or ≥92 wt %, or ≥93 wt %, or ≥94 wt %, based on the weight of the composition.

K4] The composition of any one of M3]-J4] above, where the sum of components a, b, c, d and e is present in an amount ≤100 wt %, or ≤99 wt %, or ≤98 wt %, or ≤97 wt %, or ≤96 wt %, based on the weight of the composition.

L4] The composition of any one of A]-K4] above, where the composition has a scrub resistance, as indicated by the number of scrub strokes to create a crack in a coating formed from the composition, ≥1800, or ≥1850, or ≥1900, or ≥1920, or ≥1950, or ≥1980, or ≥2000, and/or ≤5000, or ≤4000. See Experimental section.

M4] The composition of any one of A]-L4] above, where the composition has a thermal storage stability as indicated by a pH rate (%) increase ≤1.0, or ≤0.80, or ≤0.60, or ≤0.40, or ≤0.20, or ≤0.10, and/or ≥0. See Experimental section: 50° C. for 10 days, circulating air.

N4] The composition of any one of A]-M4] above, where the composition has a freeze-thaw stability as indicated by a pH rate (%) increase ≤3.0, or ≤2.8, or ≤2.6, or ≤2.4, or ≤2.3, or ≤2.2, and/or ≥0.1. See Experimental section: −6° C. for 16 hours, air, then at a temperature from 22° C. to 23° C. for 8 hours, air.

O4] The composition of any one of A]-N4] above, where the composition has a thermal storage stability as indicated by a KU viscosity rate (%) increase ≤9.0, or ≤8.5, or ≤8.0, or ≤7.5, or ≤7.0, or ≤6.5, and/or ≥1.0. See Experimental section: 50° C. for 10 days, circulating air.

P4] The composition of any one of A]-04] above, where the composition has a freeze-thaw stability as indicated by KU viscosity rate (%) increase ≤15, or ≤10, or ≤8.0, or ≤6.0, or ≤5.0, or ≤4.5, or ≤4.3, or ≤4.2, and/or ≥0.5. See Experimental section: −6° C. for 16 hours, air, then at a temperature from 22° C. to 23° C. for 8 hours, air.

Q4] The composition of any one of A]-P4] above, where the composition has a KU viscosity after 24 hours at a temperature from 22° C. to 23° C., ambient atm., ≤500, or ≤400, or ≤300, or ≤250, or ≤200, or ≤150, or ≤140, or ≤130, or ≤125, and/or ≥80, or ≥90, or ≥95, or ≥100, or ≥105, or ≥110, or ≥115 Krebs units.

R4] The composition of any one of A]-Q4] above, where the composition has a pH value after 24 hours at a temperature from 22° C. to 23° C., ambient atm., ≥7.88, or ≥7.89, or ≥7.90, or ≥7.91, and/or ≤10.0, or ≤9.50, or ≤9.00, or ≤8.50, or ≤8.20, or ≤8.20, or ≤8.08, or ≤8.06, or ≤8.04, or ≤8.02, or ≤8.00.

S4] The composition of any one of A]-R4] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a fluorocarbon, based on the weight of the composition, and further the composition does not comprise a fluorocarbon.

T4] The composition of any one of A]-S4] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a fluorocarbon polymer, based on the weight of the composition, and further the composition does not comprise a fluorocarbon polymer.

U4] The composition of any one of A]-T4] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a fluorocarbon polymer emulsion, based on the weight of the composition, and further the composition does not comprise a fluorocarbon polymer emulsion.

V4] The composition of any one of A]-U4] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of an epoxy polymer, based on the weight of the composition, and further the composition does not comprise an epoxy polymer.

W4] The composition of any one of A]-V4] above, wherein the composition comprises ≤1.0 ppm, or ≤0.50 ppm, or ≤0.20 ppm, or ≤0.10 ppm, or ≤0.05 ppm, or ≤0.02 ppm, or ≤0.01 ppm of a halogenated polymer, based on the weight of the composition, and further the composition does not comprise a halogenated polymer.

X4] The composition of any one of A]-W4], where the composition is a paint or a coating.

A5] A process to form the composition of any one of A]-X4] above, the process comprising mixing at least components a and b.

B5] The process of A5] above, where the process comprises mixing at least components a, b in the presence of at least a portion of component d (water).

C5] The process of A5] or B5] above, where the mixing takes place in the presence of component c (at least one filler), component d (water), component e (polymer emulsion) and component f (at least one additive).

D5] The process of any one of A5]-C5] above, where the mixing takes place at ≥200 rpm, or ≥300 rpm, or ≥400 rpm, or ≥500 rpm, or ≥600 rpm, or ≥700 rpm, or ≥800 rpm.

E5] The process of any one of A5]-D5] above, where the mixing takes place at ≤4000 rpm, or ≤3500 rpm, or ≤3000 rpm, or ≤2500 rpm, or ≤2000 rpm, or ≤1900 rpm, or ≤1800 rpm.

F5] A process of coating a surface, the process comprising applying to the surface the composition of any one of A]-X4] above.

G5] The process of F5] above, where the surface is a cement surface, a wood surface, a plastic surface, a metal surface, a ceramic surface or a fabric surface, and further a cement surface, a wood surface, a plastic surface, or a metal surface.

A6] An article comprising at least one component formed from the composition of any one of A]-X4] above.

B6] The article of A5] above, where the article is a coated surface.

C6] An article comprising at least one component formed from the process of any one of A5]-G5] above.

D6] The article of C6] above, where the article is a coated surface.

E6] The article of B6] or D6] above, where the surface is a cement surface, a wood surface, a plastic surface, a metal surface, a ceramic surface or a fabric surface, and further a cement surface, a wood surface, a plastic surface, or a metal surface.

### Experimental

Reagents are listed in Table 1. Amine boiling points are listed in Tables 2A and 2B.

TABLE 1
Reagents

| Product Name | | Chemical Description, Formula, and/or Structure |
|---|---|---|
| pH neutralizer 1 | AMP-95 | 2-amino-2-methyl-1-propanol with 5 wt% water, available from |
| | | ANGUS |
| | | 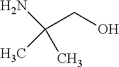 |
| pH neutralizer 2 | | Ethylenediamine, available from |
| | | Sinopharm Chemical Reagent Co., Ltd. |
| | | 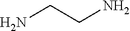 |
| pH neutralizer 3 | | Cyclic amine, available from Sinopharm Chemical Reagent Co., Ltd.) |
| | | 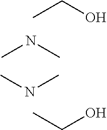 |
| pH neutralizer 4 | | Cyclic amine |
| | | 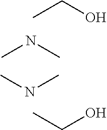 |
| Freeze-thaw | Propylene glycol | C₃H₈O₂, available from Sinopharm Chemical Reagent Co., Ltd. |
| stabilizer | | |
| Dispersing agent | OROTAN 1288 | An aqueous polycarboxylate-2-propenoic acid, homopolymer, |
| | | sodium salt, available from The Dow Chemical Company |
| Wetting Agent | TERGITOL CA-90 | Non-ionic surfactant, available from The Dow Chemical Company |
| Anti-foaming agent | BYK-024 | Silicone-containing defoamer, available from BYK |
| Inorganic Metal | Titanium dioxide | TiO₂, available from DuPont |
| Oxide | | |
| Filler | CaCO3, 700 mesh | CaCO₃, available from Guangfu Construction Materials |
| Filler | Calcined KAOLIN, 1250 | Calcined Kaolin powder, |
| | mesh | available from Guangfu Construction Materials |
| Filler | Talcum powder, 1250 | Talcum powder, available from Guangfu Construction Materials |
| | mesh | |
| Rheology modifier | NATROSOL 250 HBR | A water-soluble non-ionic hydroxyethylcellulose, |
| | | available from Ashland |
| Rheology modifier | ACRYSOL RM-8W | A nonionic urethane rheology modifier, available from |
| | | The Dow Chemical Company |
| Rheology modifier | ACRYSOL TT-935 | A hydrophobically modified anionic thickener, available from The |
| | | Dow Chemical Company |
| Binder | PRIMAL SF-105 | An acrylic-styrene copolymer emulsion, available from |
| | | The Dow Chemical Company |
| Coalescing agent | UCAR Filmer IBT | 2,2,4-Trimethyl-1,3-pentanediol monoisobutyrate, available from |
| | | The Dow Chemical Company |

TABLE 2A
Boiling Points for Noted Amines*

| Amine | Boiling Point (° C.) at 760 mm Hg |
|---|---|
| diethanolamine | 280 |
| ethanolamine | 170 |
| triethylamine | 89.5 |
| 2-amino-2-methyl-1-propanol | 165 |
| N-methyldiethanolamine | 243 |
| N,N-dimethylethanolamine | 135 |
| Ethylenediamine | 116.5 |
| Cyclic amine (pH neutralizer 3) | 300** |

*Note, those amines with a boiling point (at 760 mm Hg) less than 250° C., are considered a VOC in coating applications.
**See Table 2B below.

TABLE 2B
Boiling Points for Cyclic Amine (pH neutralizer 3)

| | | boiling | |
|---|---|---|---|
| | pressure | point | |
| | (mm | degree | |
| | Hg) | C. | source |
| Experi- | 50 | 220 | (1) Pyman, F. L.; Journal of the Chemical |
| mental | | | Society, Transactions, (1908), 93, |
| | | | 1793-1807, CAplus |
| Experi- | 12 | 190 | (3) Demarcq, Michel Charles; Compt. |
| mental | | | rend., (1961), 252, 3454-6, CAplus |
| Experi- | 10 | 180 | (4) Gold-Aubert, Ph.; Helvetica Chimica |
| mental | | | Acta, (1959), 42, 1156-9, CAplus |
| Experi- | 7 | 165 | (5) Dell, H. D.; Naturwissenschaften, |
| mental | | | (1966), 53(16), 405, CAplus |
| Predicted | 760 | 305 | (1) Calculated using Advanced Chemistry |
| Extrapo- | 760 | 294 | Development (ACD/Labs) Software |
| lated* | | | V11.02 ( © 1994-2023 ACD/Labs) |
| | | | extrapolated based on the equation in |
| | | | the plot |
| Average** | 760 | 300 | |

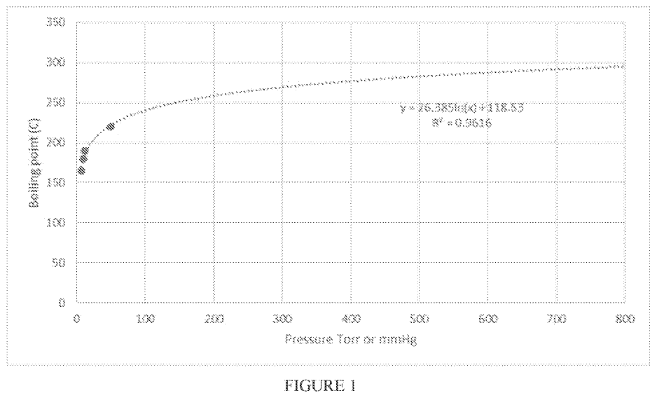

*See FIG. 1.
**Average = [(Predicted + Extrapolated)/2]

### Compositions

Compositions are shown in Table 3 below.

TABLE 3
Compositions

| | | SI | | | | |
|---|---|---|---|---|---|---|
| | Ingredient | Units | CE1 | IE1 | CE2 | IE2 |
| Grinding | Water | g | 260 | 260 | 260 | 260 |
| process | Propylene glycol | g | 10 | 10 | 10 | 10 |
| | TERGITOL | g | 2 | 2 | 2 | 2 |
| | CA-90 | | | | | |
| | NATROSOL | g | 3 | 3 | 3 | 3 |
| | 250 HBR | | | | | |
| | AMP-95 (95%) | g | 0.5 (amine - | | | |
| | pH neutralizer 1 | | active | | | |
| | | | ingredient) | | | |
| | Ethylenediamine | | | | 0.5 | |
| | pH neutralizer 2 | | | | | |
| | Cyclic Amine | g | | 0.5 (cyclic | | |
| | pH neutralizer 3 | | | amine - active | | |
| | | | | ingredient) | | |
| | Cyclic Amine | | | | | 0.5 (cyclic |
| | pH neutralizer 4 | | | | | amine - active |
| | | | | | | ingredient) |
| | OROTAN 1288 | g | 4.5 | 4.5 | 4.5 | 4.5 |
| | BYK-024 | g | 1 | 1 | 1 | 1 |
| | Titanium dioxide | g | 100 | 100 | 100 | 100 |
| | CaCO₃, 700mesh | g | 200 | 200 | 200 | 200 |
| | Calcined Kaolin, | g | 120 | 120 | 120 | 120 |
| | 1250 mesh | | | | | |
| | Talcum powder, | g | 70 | 70 | 70 | 70 |
| | 1250 mesh | | | | | |
| Letdown | PRIMAL SF-105 | g | 125 | 125 | 125 | 125 |
| process | UCAR Filmer | g | 22.5 | 22.5 | 22.5 | 22.5 |
| | IBT | | | | | |
| | BYK-024 | g | 1 | 1 | 1 | 1 |
| | ACRYSOL TT- | g | 6.5 | 6.5 | 6.5 | 6.5 |
| | 935 | | | | | |
| | Water | g | Sum up | Sum up | Sum up | Sum up |
| | | | to 1000 | to 1000 | to 1000 | to 1000 |

### Composition Preparation

Each composition was prepared at room temperature (ambient atmosphere). Each composition was prepared using a grinding process and a letdown process, each process described below.

### Grinding Process:

A dispersing plate (about 5 cm diameter) was installed on a dispersing machine (type: SFJ-400, from Shanghai Tianchen). Next, water (260 g) was added into a one liter, stainless steel cup. NATROSOL 250 HBR was added to the steel cup, and the contents of the cup were dispersed at 450 rpm for 10 minutes. The pH neutralizer was added to the contents in the steel cup. The dispersed mixture within the cup thickened gradually in about 5 minutes. Next, TERGITAL CA-90, OROTAN 1288, BYK-024 and propylene glycol were respectively added into the thickened mixture, and the cup contents were dispersed for another 10 minutes (450 rpm). Titanium dioxide and the fillers were added into the mixture, while gradually increasing the dispersing speed to 1800 rpm in response to the increasing viscosity. The mixture was dispersed for an additional 30 minutes to guarantee the homogeneity of the mixture, as determined by visual inspection.

### Letdown Process:

The dispersing plate was replaced with a stirrer (about 5 cm in diameter), and the above mixture was stirred at 1800 rpm. PRIMAL SF-105, UCAR Filmer IBT and BYK-024 were added respectively to the mixture. The stirring speed was gradually decreased to 800 rpm, in response to a decreasing viscosity. The stirring was maintained at 800 rpm for 15 minutes. Next, ACRYSOL TT-935 was added to the mixture, and the stirring speed was increased up to 1800 rpm, in response to an increase in viscosity, and the stirring was maintained for 10 minutes. Finally, the remainder of the water was added into the mixture and the final mixture was stirred for another 10 minutes. Each composition was evaluated as discussed below.

### Composition—Thickening Efficiency

For each composition, the KU viscosity was measured at the following stages of the composition preparation and storage: a) after adding the pH neutralizer to the formulation (grinding process) and the formulation thickened, b) after completing the grinding process (after dispersing the mixture at 1800 rpm for 30 minutes), c) after completing the letdown process (after stirring the mixture at 1800 rpm for 10 minutes), and d) after storing the composition for 24 hours at a temperature from 22° C. to 23° C. and ambient atmosphere. The results are shown in Table 4.

The KU viscosity was measured in accordance with ASTM D562, using a Brookfield Viscometer (Model KU-2 Digital Stomer-type viscometer), at a temperature from 22° C. to 23° C. Each composition (500 g) was poured into an “500 mL” plastic cylindrical container, and the container was placed under the KU viscometer. The power to the viscometer was turned on, and the operation handle was moved to its lowest position. The paddle spindle (aligns with ASTM D562) was immersed into the middle of the sample, wherein the spindle did not touch the sides of the container. The display reading was allowed to stabilize (about 5 seconds), and the viscosity of the composition was recorded (units in Krebs Units (or KU)). The operation handle was raised to the top position, and the paddle spindle was removed and clean. For each composition, three viscosity measurements were taken, and an average reported.

TABLE 4
KU Viscosity

| | | CE1 | IE1 | CE2 | IE2 |
|---|---|---|---|---|---|
| KU | Water + NATROSOL | 56.5 | 57.8 | 77.6 | 59.9 |
| viscosity | 250 HBR + pH | | | | |
| (units = | neutralizer | | | | |
| Krebs | After grinding process | 80 | 86 | 100 | 87 |
| Unit = | After letdown process | 98 | 105 | 103 | 110 |
| KU) | After 24 hours of | 109 | 118 | 112 | 120 |
| | standing at 22° C.- | | | | |
| | 23° C. and ambient | | | | |
| | atmosphere | | | | |
| pH | After 24 hours of | 8.36 | 7.91 | 8.93 | 8.00 |
| | standing at 22° C.- | | | | |
| | 23° C. and ambient | | | | |
| | atmosphere | | | | |

### Storage Stability and Scrub Resistance

### Thermal Storage Stability:

According to test method GB/T 6753.3-1986, the composition (200 g) was sealed (plastic (PP) jar with cap, composition under an air atmosphere) and put in an oven (circulating air oven) at 50° C. for 10 days. The pH and KU viscosity were measured before (initial reading) and after (final reading) thermal storage. The pH was measured with a Mettler Toledo SevenCompact pH meter. The KU viscosity was measured with the Brookfield KU Viscometer, as discussed above. Results are shown in Table 5.

### Freeze-Thaw Storage Stability:

According to GB/T 9168-2008, the composition (200 g) was sealed (plastic (PP) jar with cap, composition under an air atmosphere) and put in a refrigerator set at −6° C., for 16 hours, air atm., and then kept at a temperature from 22° C. to 23° C., for 8 hours (air atm.). This freeze-thaw storage process was repeated for three cycles. The pH and KU viscosity were measured before (initial reading) and after (final reading) the “three cycles” of this freeze-thaw storage. The pH was measured with the Mettler Toledo SevenCompact pH meter. The KU viscosity was measured with the Brookfield KU Viscometer, as discussed above. Results are shown in Table 5.

### Scrub Resistance

For each composition, the composition was applied onto a cement board (Shanghai Modern Instrument), in accordance with GB/T 9266-2009, using an applicator (Shanghai Modern Instrument, SZQ-150 μm). Each coating had a wet film thickness of 250 μm. Note, the applicator had a groove of 250 μm to ensure a wet coating thickness of 250 μm. The coated cement board was dried at 23±2° C. and 50±5% RH conditions, for seven days (ambient atm), to obtain a dried coating. The aqueous scrubbing solution was a “5 wt %, based on the weight of the solution, of detergent powder (Brand: ARIEL from P&G) in water,” with a pH value in the range of 9.5-11.0. The scrubbing test was conducted using a “Auto Scrub Machine” available from SHEEN (wet abrasion scrub tester, REF 903) with a natural bristle brush. The brush motion was horizontal, and the scrub rate was 37 cycles per minutes, where each cycle represented two horizontal strokes, one across and one back across the dried coating. The scrub resistance was recorded as the number of strokes required to create a breakage in the coating, as observed by visual examination. Note, the breakage occurred through the entire coating thickness. For each composition, two test samples were examined and the average recorded. Results are shown in Table 5.

TABLE 5
Stability and Scrub Results

| | | CE1 | IE1 | CE2 | IE2 |
|---|---|---|---|---|---|
| Thermal | Initial pH | 8.38 | 7.92 | 8.86 | 8.01 |
| storage | pH rate (%) increase* | 0.2 | 0.1 | 0.8 | 0.1 |
| stability | Initial KU viscosity | 119.2 | 115.1 | 122.5 | 127.5 |
| | KU viscosity rate (%) | 9.8 | 2.5 | 9.2 | 6.5 |
| | increase** | | | | |
| Freeze | Initial pH | 8.61 | 8.04 | 9.07 | 8.17 |
| thaw | pH rate (%) increase* | 3.0 | 1.6 | 1.6 | 2.1 |
| stability | Initial KU viscosity | 125.3 | 116.8 | 118.4 | 124.6 |
| | KU viscosity rate (%) | 15.4 | 1.0 | 5.5 | 4.1 |
| | increase** | | | | |

| | | | | |
|---|---|---|---|---|
| Scrub Resistance | 1991 | 2187 | 2096 | 2012 |
| (number of scrub strokes to create | | | | |
| a breakage in the dried coating) | | | | |

*pH rate (%) increase = {[(final pH) − (initial pH)]/(initial pH)} × 100
**KU viscosity rate (%) increase = {[(final viscosity) − (initial viscosity)]/(initial viscosity)} × 100

### Summary of Results

As seen in Table 4, each KU viscosity value for compositions IE1 and IE2 was higher than the respective value for composition CE1. These results showed that the thickening efficiency of each of IE1 and IE2 was higher than that of CE1. This may be due to the multi-hydroxyl groups in the structure of the cyclic amine. Perhaps these hydroxyl groups participate in hydrogen bonding to form a denser network structure, which results in an increase in viscosity. Each composition IE1 and IE2 maintained a lower pH value, as compared to CE1 and CE2, and these lower pH values did not influence the higher viscosity for each respective composition.

As seen in Table 5, for the thermal storage and the freeze-thaw storage, the respective “KU viscosity rate of increase” values were lower for the IE1 and IE2 compositions, as compared to the CE1 and CE2 compositions. The IE1 and IE2 compositions also had lower values for the “pH rate of increase” during the thermal storage. These results indicate that the IE1 and IE2 compositions were each more stable during the thermal storage and the freeze-thaw storage, as compared to the CE1 and CE2 compositions.

The scrub resistance was better for the IE1 and IE2 compositions, as compared to the CE1 composition, indicating good abrasion resistance for the IE1 and IE2 compositions. Composition IE1 outperformed both CE1 and CE2 compositions, in terms of the scrub resistance.

1. A composition comprising at least the following components a and b):
a) at least one structure selected from Structures 1), 2), 3) or any combination thereof: 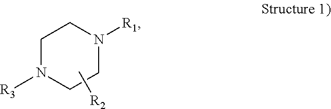
wherein R1 is a C1-C6 alkoxyl group; R2 is H or an alkyl group; R3 is H or a C1-C6 alkoxyl group; 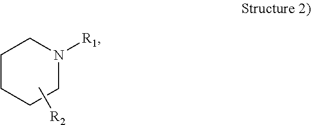
wherein R1 is a C1-C6 alkoxyl group; R2 is H or an alkyl group; 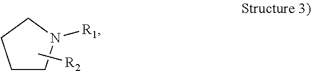
wherein R1 is a C1-C6 alkoxyl group; R2 is H or an alkyl group; and
b) at least one inorganic metal oxide.

2. The composition of claim 1, wherein the weight ratio of component b to component a is from 40 to 500.

3. The composition of claim 1, wherein component a is selected from at least one structure selected from the group consisting of the following structures 1a) through 4g) as shown below: 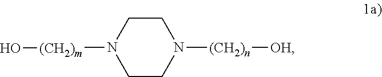
where n is an integer from 1 to 6 and m is an integer from 1 to 6; 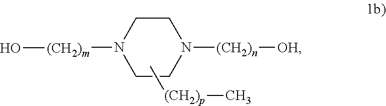
where n is an integer from 1 to 6, m is an integer from 1 to 6 and p is an integer from 0 to 5; 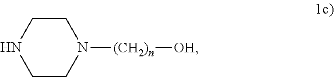
where n is an integer from 1 to 6; 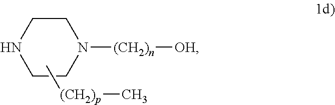
where n is an integer from 1 to 6; and p is an integer from 0 to 5; 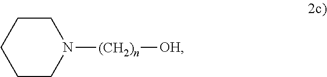
where n is an integer from 1 to 6; 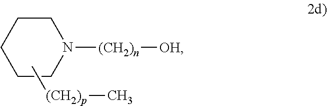
where n=is an integer from 1 to 6 and p is an integer from 0 to 5; 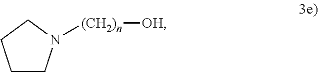
where n is an integer from 1 to 6; 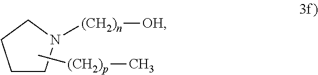
where n is an integer from 1 to 6 and p is an integer from 0 to 5; and
4g) any combination thereof.

4. The composition of claim 1, wherein for component a, Structures 1), 2), or 3) each, independently, has a boiling point (at 760 mm Hg) ≥250° C.

5. The composition of claim 1, wherein component a is selected from Structure 1).

6. The composition of claim 5, wherein component a is at least one structure selected from the group consisting of the following structures 1a), 1b) and 4g), each as shown above.

7. The composition of claim 5, wherein component a is at least one structure selected Structure 1a).

8. The composition of claim 1, wherein component b is a metal dioxide.

9. The composition of claim 1, wherein the composition further comprises at least one filler as component c.

10. The composition of claim 9, wherein the composition comprises, as component c, at least three fillers (F1, F2 and F3).

11. The composition of claim 1, wherein the composition further comprises water as component d.

12. The composition of claim 1, wherein the composition further comprises a polymer emulsion as component e.

13. The composition of claim 1, wherein the component a is present in an amount from 0.005 wt % to 3.0 wt %, based on the weight of the composition.

14. The composition of claim 1, wherein the component b is present in an amount from 2.0 wt % to 50 wt %, based on the weight of the composition.

15. The composition of claim 1, wherein the composition has a Scrub Resistance ≥1800 strokes.

16. The composition of claim 1, wherein the composition has a thermal storage stability as indicated by a pH rate (%) increase ≤1.0.

17. The composition of claim 1, wherein the composition has a thermal storage stability as indicated by a KU viscosity rate (%) increase ≤9.0.

18. The composition of claim 1, wherein the composition is a paint or a coating.

19. A process to form the composition of claim 1, the process comprising mixing at least components a and b.

20. An article comprising at least one component formed from the composition of claim 1.
